(19) United States
(12) Patent Application Publication
(10) Pub. No.: US 2016/0170102 A1
(43) Pub. Date: Jun. 16, 2016

(54) SOLAR LIGHT MANAGEMENT

(71) Applicant: BASF SE, Ludwigshafen (DE)

(72) Inventors: Andreas HAFNER, Gelterkinden (CH); Adrian VON MUEHLENEN, Zofingen (CH); Olivier ENGER, Therwill (CH); Benjamin GALLINET, Muttenz (CH); Rolando FERRINI, Bern (CH); Nenad MARJANOVIC, Frenkendorf (CH); Martin STALDER, Oberwil (CH); Fabian LUETOLF, Magden (CH); Guillaume BASSET, Huningue (FR)

(21) Appl. No.: 14/905,400

(22) PCT Filed: Jul. 8, 2014
(86) PCT No.: PCT/EP2014/064655

§ 371 Date: Jan. 15, 2016

(30) Foreign Application Priority Data
Jul. 18, 2013 (EP) 13177060.4

(51) Int. Cl. G02B 5/18; F21S 11/00; G02B 5/20

(52) U.S. Cl. CPC G02B 5/1809; G02B 5/203; F21S 11/007; E06B 2009/2417

(57) ABSTRACT

A translucent construction element comprising a layer of translucent substrate, which contains a surface structured with nanoplanes of inclined angle relative to the substrate plane, and coated with an interrupted metallic layer covering at least a part of said nanoplanes, is characterized by a high density of interruptions in the metallic layer of low thickness; the periodicity of interruptions in the metallic layer generally is from the range 50 to 1000 nm and the thickness of the metallic layer typically is from the range 1 to 50 nm. The construction element may be integrated, for example, into windows, plastic films or sheets or glazings, especially for the purpose of light management.

The invention relates to the management of radiation, and more specifically to the seasonal modification of the transmission of solar light through a window into the interior space of a building or vehicle, by a device comprising interrupted metallic structures on a transparent substrate.

Certain structures are known which provide filters or gratings to influence the reflection of electromagnetic waves when they are irradiated by these electromagnetic waves. The structures are used in several different applications like security devices (e.g. for banknotes, credit cards, passports, tickets and the like), heat-reflecting panes or windows and spectrally selective reflecting pigments.

Heat-reflecting structures containing a layer of a highly refractive material such as ZnS are described in EP-A-1767964 and WO2012/147052 as a zero-order diffractive filter; the pane is proposed for IR-management purposes in solar-control applications where the transmission of solar energy into a building or a vehicle has to be controlled. The functionality of the filter is based on certain grating structures within the highly refractive layer.

Some commercial heat management films comprise multilayers including silver and/or dielectric layers any provide a certain angular dependence of reflection. U.S. Pat. No. 7,727,633 and U.S. Pat. No. 7,906,202 describe a combination of two optical layers, which help to reject solar light in the infrared wavelength range: The first is a polymeric multilayer film which provides a high reflectivity for a limited wavelength range in the infrared; this film is composed of tens or hundreds of sub-layers (Bragg reflector) resulting in an angle sensitive reflection band, which moves toward the visible as the incidence angle of the light is increased. The second layer involves nanoparticles, which absorb light in the infrared wavelength range.

US-A-2011-203656 describes some metallic nanostructures on a transparent polymer substrate for use as a transparent electrode in solar cells or light emitting diodes. WO2004/019083 describes a diffractive grating containing reflective facets, which are partly coated with an electrically conducting material for various applications such as optical telecommunication. G. Mbise et al., Proc. SPIE 1149, 179 (1989), report an angular dependent light transmission through Cr-films deposited on glass under an oblique angle.

It has now been found, that a strong angular dependence of light transmission through a (typically flat) translucent (especially transparent) substrate such as glass or layered glazing sheets may be achieved by attaching certain metallic nanostructures onto the substrate surface, retaining the optical quality of the substrate. The metallic nanostructures are aligned in a direction different from the substrate plain and separated from each other (thus forming an interrupted metallic layer). For reasons of simplicity, the metallic nanostructures contained in the present device and the present window are also referred to as “metallic structures”.

The present invention thus relates to an optical device comprising the substrate with these metallic structures on its surface. The device may be attached to a window glazing, or integrated into such a glazing, thus providing a modulation of light transmittance useful for solar light and/or heat management applications. A thus enhanced window shows angle dependent transmission properties, which lead to reduced solar light transmission at grazing light incidence, as typically occuring in summer in temperate climate zones such as Europe or North America at high solar altitude, and to comparably higher solar light transmission at nearly vertical incidence, as typically occuring at low solar altitude in winter. In consequence, the window equipped according to the present invention provides heat rejection in summer, and remains heat transparent in winter.

The term “surface” as used within the present invention denotes a surface of a material which may be covered by another solid material (such as metal, encapsulating layer etc.), thus forming an internal surface of the construction element, device or window pane of the invention, or which forms the outer surface of the construction element, device or window pane of the invention.

The term “substrate plane” as used within the present invention denotes the plane of the substrate's macroscopic extension (indicated in FIG. 1 a as x- and y-axis), where the metallic nanostructures are attached onto the substrate surface. While the substrate may be curved in the macroscopic scale, deviations from flatness in the microscopic scale are negligible, the substrate surface is thus referred to in the following as forming a flat plane. The substrate surface, including the metallic nanostructures, may further be embedded in, or covered by, one or more further layers of translucent or transparent material.

The term “nanoplane” as used within the present invention denotes a structure which may extend in one dimension within the substrate plane over the whole of said plane, and in its second dimension up to 1000 nm (generally much less, as apparent from the dimensions given in the detailled description of the invention following below). The nanoplane may be curved or preferably flat. The nanoplane is covered or partly covered by the metallic layer, both of which may further be embedded in, or covered by, one or more further layers of translucent or transparent material.

The term “inclined angle” as used within the present invention denotes an angle of inclination of the substrate's nanoplanes relative to the substrate plane; the nanoplanes of inclined angle thus may stand perpendicular relative to the substrate plane, but are not parallel to the substrate plane. Preferred angles of inclination are as defined below.

The term “nanostructure” as used within the present invention, relating e.g. to the metallic layer on the nanoplane, denotes a structure which may extend in one dimension within the substrate plane, and in the dimension rectangular to the substrate plane, each up to 1000 nm (generally much less, as apparent from the dimensions given in the detailled description of the invention following below), and whose other dimension within the substrate plane may extend over the whole substrate. As noted below, its smallest dimension (thickness of the nanostructure) typically is from the range 1 up to 75 nm, as indicated below. The nanoscale of these structures also serves to retain the optical quality of the chosen substrate, such as full transparency.

The term “translucent” or “translucency” as used within the present invention denotes the property of a material, typically of the substrate or an encapsulating medium, to allow light of the solar spectrum to pass through said material (general wavelength range from ca. 350 up to ca. 2500 nm). The term “transparent” or “transparency” as used within the present invention denotes the property of a material, typically of the substrate or an encapsulating medium, to allow light of the solar visible spectrum to pass through said material with a minimum of scattering effects. The term generally means transparency for electromagnetic waves from the visible range of solar light, permitting transmission of at least 10%, preferably at least 30%, and more preferably at least 50% of solar radiation energy of the visible range (especially 400 to 700 nm).

The term “window” as used within the present invention denotes a construction element, typically in a vehicle, in agriculture or especially in architecture, which is placed in a wall, or constitutes said wall, whereby the wall typically separates an interior room (typically an interior room of a vehicle or especially a building) from another interior room or especially an exterior room (typically the outdoor environment), in order to allow light to pass through the wall (typically sunlight passing from the exterior into the interior room).

The term “window pane” as used within the present invention denotes the translucent, especially transparent, construction element of the window consisting of translucent, especially transparent, material, typically the window without frame or fittings.

A typical example for a transparent window pane according to the invention is a building window, or vehicle window e.g. in a bus or train.

The term “metallic layer” as used within the present invention is essentially isotropic, thus generally providing metallic conductivity in both dimensions.

The term “interrupted metallic layer” as used within the present invention denotes a metallic layer which is interrupted in one dimension with a certain periodicity, essentially without metallic conductivity between 2 or more interrupted sections of said layer, while there is metallic conductivity within the non-interrupted stripes of this layer in its second dimension.

The term “periodicity of interruptions” as used within the present invention denotes the shortest width (mean value) of the spacing between 2 neighbouring sections of the metallic layer plus the width of one neighbouring section of the metallic layer; it is typically about the same as the periodicity of the grating periodicity (measured, for instance, as distance of 2 neighbouring peak centers of the grating, in direction perpendicular to the grating length).

A typical example for another translucent construction element according to the invention, which is non-transparent, is a glass facade element which scatters and/or absorbs visible light, but still allows some solar radiation to pass. This type of translucent construction element may also be covered on its interior side by an opaque material, such as coating or a wall element (for example a black coating or film functioning as a thermal bridge to the interior). As an effect, the radiation passing the translucent construction element is absorbed and/or reflected by the opaque material. The modulation of light transmittance through the translucent element provided by the present invention thus provides a modulation of the effects of light transmission, such as thermal effects, on the interior side of the translucent construction element and its opaque covering.

Present invention thus primarily pertains to a translucent construction element, such as a window pane or facade element, comprising a layer of translucent, especially transparent, substrate, which contains a surface which is structured with flat or curved nanoplanes of inclined angle relative to the substrate plane, which nanoplanes are coated with metal. The substrate thus carries the metallic nanostructures in the form of an interrupted metal layer on its structured surface. This composite layer is generally characterized in that the periodicity of interruptions ranges from 50 up to 1000 nm and the thickness of the metallic structure in its smallest dimension, typically in direction perpendicular to the surface of the substrate's nanoplanes, ranges from 1 up to 75 nm, as explained below in more detail.

The angle of inclination of the substrate's nanoplanes relative to the substrate surface typically ranges from 10-90°, preferably from 30-90°, where 90° stands for a nanoplane extending rectangular to the substrate plane (i.e. in direction of the z-axis as shown in FIG. 1a).

The invention thus provides a translucent construction element comprising a layer of translucent substrate, which contains a surface structured with metallized nanoplanes of inclined angle relative to the substrate plane. The metallization is provided as a coating in the form of an interrupted metallic layer covering at least a part of said nanoplanes, characterized in that the periodicity of interruptions in the metallic layer is from the range 50 to 1000 nm and the thickness of the metallic layer is from the range 1 to 50 nm. Another embodiment is a translucent construction element comprising a layer of translucent substrate, which contains a surface structured with metallized nanoplanes of inclined angle relative to the substrate plane as described above, where the periodicity of interruptions in the metallic layer is from the range 50 to less than 500 nm, especially lower than 500 nm as specified further below, and the thickness of the metallic layer is from the range 1 to 75 nm. More preferred ranges for periodicity, and for thickness of the metallic layer, are explained below.

The invention further pertains to an optical device comprising said characterizing features.

The substrate typically comprises a flat or bent polymer sheet or glass sheet, or polymer sheet and glass sheet. The metallic structure on the substrate is typically encapsulated by a suitable translucent, or preferably transparent, medium.

Interrupted metallic structures on the surface of the transparent substrate, as required in the device of the present invention, typically are prepared by partial metallization of the structured surface by processes such as vapor deposition, sputtering, printing, casting or stamping. Full coverage of the surface by metal can be prevented, for example, by application of a shadow mask, photoresist techniques. In a preferred method, the metal structures are applied by directed deposition of the metal under an oblique angle onto a previously prepared grating structure, e.g. on a glass surface or on a resin surface, as explained further below.

The devices of the invention, such as films, comprise metallic structures and may be combined with further known measures for light management and/or heat management, such as films. The devices or films may be designed to show colored or color neutral transmission properties. Devices of the invention, such as films or glazings, have the additional advantage of cost effective production (processes including roll-to-roll hot embossing or UV replication and dielectric thin film coating processes).

The metallic structures are preferably arranged on the surface of the structured substrate in the form of linear stripes on the underlying structure, which typically is a grating, for example a grating as known for zero-order reflection devices, some of which have been described in EP-A-1767964 and WO2012/147052 previously mentioned. The metallic nanostructures thus form a layer which is interrupted in one dimension with abovesaid periodicity, while there is metallic conductivity within the non-interrupted stripes of this layer in its second dimension. The arrangement is most preferably on a substrate which is macroscopically flat, as shown in FIG. 1a wherein the rectangular coordinates indicate a preferred spatial orientation of the whole device with the metallic nanostructures on the substrate surface (metal structures symbolized by lines on the surface) and interruptions (symbolized by the blank gaps between these lines); the x-axis therein points, within the substrate plane, in direction of the periodicity; the y-axis therein points within the substrate plane in direction parallel with the grating; the z-axis stands perpendicular on the substrate plane; i represents the incoming light forming an angle θ with the z-axis (θ=0° represents light falling perpendicularly on the window).

In a preferred embodiment, the final window pane (or facade element) thus is installed with horizontal or nearly horizontal grating lines (i.e. deviating from exact horizontal alignment by up to 10°, especially only up to 5°).

The metal (of the interrupted metallic layer) basically may be selected from any substance showing metallic conductivity, and which is generally able to interact with light through a surface plasmon or polaron mechanism. Besides metals, semiconducting materials such as silicon (Si), indium tin oxid (ITO), indium oxide, Aluminum doped zinc oxide (AZO), Gallium doped zinc oxide (GZO) and similar materials thus may be used. The metal is preferably selected from the group consisting of silver, aluminum, gold, copper, platinum; especially preferred is silver.

In a preferred embodiment, the window or device of the invention comprises its structured pane with horizontal gratings, in order to allow for a high angle θ (grazing light) in summer, and a small angle θ in winter in temperate climate zones. However, depending on the needs and architectural forms, other arrangements and directions of the grating may be chosen to obtain the desired angle-dependent effect.

A number characterizing the properties of devices according to the present invention is the ratio of solar light transmission at 2 different angles of incidence θ, for example T_{TS}(0°)/T_{TS}(60°). Tis is the total solar transmission defined according to the industrial standard ISO 9050 and ISO 13837. The described devices/films provided by the invention lead to T_{TS}(0°)/T_{TS}(60°)>1.25.

The substrate as well as the embedding medium generally can be of any form or material as far as it is translucent, and especially transparent, to at least a part of solar electromagnetic radiation. The device of the invention comprises at least one substrate, which is preferably a dielectricum or an electrical isolator. The substrate may be of any material the person skilled in the art knows for providing such a translucent, or preferably transparent substrate. The substrate may be flexible or rigid. The substrate may comprise glass, e.g. containing metal compounds selected from the group consisting of metal oxides, metal sulfides, metal nitrides and ceramics or two or more thereof. The shape of the device may be in form of a sheet or film or foil, or at least parts of a foil. The extension of the structure in two dimensions may range from some millimeters up to some meters or even kilometers, e.g. in the case of printing rolls. The extension in the third dimension is preferably between 10 nm and 10 mm, more preferably between 50 nm and 5 mm and most preferably between 100 nm and 5 mm. Beyond the substrate, the device may comprise further materials, like a polymer layer or a further layer. For example, the embedding medium may be a polymer layer. If the structure comprises at least one material beyond the substrate it is called a layered structure.

According to the invention, the device comprises a substrate having a surface, wherein said surface preferably has a three dimensional pattern. This surface preferably extends over the two wider dimensions of the device (surface plane), whereby the three dimensional pattern is built by a variation of the surface into the third dimension of the substrate. The surface of the substrate preferably does not deform or alter in shape on its own under normal conditions, like room temperature, normal pressure and normal humidity.

The invention thus further pertains to a method for reducing the transmission of solar light, for example to a method for reducing the transmission of IR radiation from the range 700 to 1200 nm, through a device or transparent element or window such as noted above. The method of the invention comprises integrating the above device, into a transparent element, which is typically a construction element. The transparent element may be an architectural element, an element for agriculture or an element in a vehicle, it is especially preferred in the form and/or function of window. Similarly, entry of visible light or ultraviolet light may be modified by the device of the invention noted above, where the term “modification” may stand for a desired change of color and/or increased reflection of those light frequencies, whose entry through the transparent element or window is undesired.

The device according to the invention may primarily be applied in the field of energy management. For this reason, the device is preferably structured in a way that it reflects at least 10%, preferably at least 30%, more preferably at least 50% and even most preferably at least 70% of electromagnetic radiation of grazing incidence (i.e. especially incoming light under an angle of incidence θ from the region of 700 to 1200 nm, preferably 700 to 1100 nm and more preferably 750 to 1000 nm.

In a preferred embodiment, said substrate is at least partly surrounded by a medium wherein between said substrate and said medium said surface containing the interrupted metallic structure is provided, wherein said substrate/metallic structure and said medium generally are in direct contact with each other. The configuration of the substrate at least partly being surrounded by a medium is called a layered structure in the sense of the invention.

The medium of said layered structure can fulfill different functions. One function can be to prevent the destruction of the surface of the substrate with the metallic structure on it. Therefore the medium may surround the substrate completely or at least partly.

The substrate generally may have a thickness up to several millimeter, for example ranging from 1 micrometer (e.g. in the case of polymer films) up to 10 mm (eg in the case of polymer sheets or glass); in one preferred embodiment, the substrate is a polymer layer, or combination of polymer layers, whose thickness (together) ranges from 500 nm to about 300 micrometer.

For the usage in glazings, such as architectural windows, or vehicle windows, the substrate as well as the medium should be transparent at least in the visible region in the range from 300 to 800 nm, especially 400 to 700 nm. However materials commonly used for glazings, for example glass or plastics, often also transmit electromagnetic waves in a broader region up to 2500 nm, especially up to 1400 nm.

The substrate and the medium may comprise, or be built of, any material the person skilled in the art would use to provide the before mentioned usages. The medium is preferably solid at least after contact with the substrate. Preferably, the medium is able to be coupled to the substrate without destroying the pattern thereon including the metallic structures. Examples for suitable materials and preferred preparation processes are given further below.

Additionally, the device may comprise one or more further layer(s), for example in the form of a further polymer layer. The further layer may differ in material and properties from the substrate and/or the medium. For example, the further layer may give the structure a more rigid constitution to protect especially the metallic structures from mechanical forces. For the usage in construction elements such as architectural windows, facade elements or vehicle windows, the device of the invention is typically covered on one side or on both sides by glass.

The preparation involves the step of providing the substrate comprising a surface. The substrate may be provided in form of a planar structure like a sheet, film, foil or layer or only parts thereof. The shape and dimension of the substrate may be chosen as described for the structure before. The advantageously planar structure may be flexible or rigid depending on the material it consists of.

At least one of the surfaces of the substrate is then structured in a transforming step. In one embodiment of the invention, said transforming step is selected from the group consisting of embossing, stamping and printing. These processes are well known to the person skilled in the art.

In a further step, the interrupted metallic structures are attached onto the thus prestructured substrate as explained below in detail.

In a further preferred embodiment the process is provided, wherein the substrate comprises an organic polymer, typically selected from the group consisting of polymethyl methacrylate, polyethylene terephthalate, polyethylene, polycarbonate, polyetherimide, polyetherketone, polyethylene naphthalate, polyimide, polystyrene, poly-oxymethylene, polypropylene, polyvinyl chloride, polyvinylbutyral or two or more thereof. The substrate may additionally comprise a further material, preferably any kind of hot embossable polymers or UV curable resins.

In a further aspect, the invention relates to a process to provide a way to generate a device structure in the form as described before. The process for producing a device according to the present invention comprising the steps:
i. providing a transparent substrate exposing a surface,
ii. structuring the substrate to obtain a three-dimensional pattern (exposing nanoplanes, such as by a grating) having a periodicity ranging from 50 to 1000 nm, and preferably a depth (measured rectangular to the substrate plane) from the range 30 to 1000 nm, especially 50 to 800 nm, and
iii. depositing a metal on a part of the thus structured surface, preferably by vapor deposition or sputtering under an oblique angle.

Suitable methods for patterning metallic layers and thus forming interrupted metallic structures are generally known in the art. Preferred is a method wherein a grating on the substrate is obtained by an embossing step, e.g. as described in EP-A-1767964, WO2009/068462, WO2012/147052, U.S. Pat. No. 4,913,858, U.S. Pat. No. 4,728,377, U.S. Pat. No. 5,549,774, WO2008/061930 or Gale et al., Optics and Lasers in Engineering 43, 373 (2005), as well as literature cited therein; the preparation of suitable embossing tools, such as grating masters, is explained, inter alia, in WO2012/147052, WO2009/062867, US-2005-239935, WO 95/22448; a preferred method is given by Zaidi et al., Appl. Optics 27, 2999 (1988), describing the preparation of nearly rectangular shaped photoresist gratings using standard holographic two beam interference set-up.

Other useful structuring methods to obtain the grating such as holographic patterning, dry etching etc. are described, for example, in US-2005-153464, WO2008/128365.

In a typical fabrication process, interference lithography is used to pattern a photoresist on top of a quartz or silicon substrate. The photoresist is developed and the pattern is transferred to the substrate by etching. A grating with controlled shape, depth and duty cycle is obtained.

The result of the development step may be a continuous surface relief structure, holding, for example, a sinusoidal or rectangular cross section or a cross section of a combination of several sinusoidal and/or rectangular cross sections of the obtained grating. Resists that are exposed to electron beams or plasma etching typically result in binary surface structures, typical for a rectangular form of the cross-section. Continuous and binary surface relief structures result in very similar optical behaviors. By a galvanic step the typically soft resist material then may be converted into a hard and robust metal surface, for example into a Nickel shim. This metal surface may be employed as an embossing tool.

The quartz or silicon grating, or preferably the Ni-shim, is then used as a master for replication onto the final substrate, for example a UV cured polymer material. Alternatively, replication can be effected by hot embossing at a temperature preferably above the substrate's glass transition temperature; this technique is especially effective on substrates like PET, PMMA and especially PC. With this embossing tool providing the master surface, a medium in form of a polymer layer or foil can be embossed.

The grating structures may also be transferred directly onto a glass surface. Possible transfer techniques are based on reactive ion etching or the use of replicated inorganic sol-gel materials.

The grating of the substrate (and hence the typical periodicity of interruptions of the metallic layer) is preferably of a periodicity from the range 50 to 1000 nm, more preferably 100 to 1000 nm, especially 100 to 800 nm; of special technical importance is a periodicity of less than 500 nm, such as 50 to 490 nm, especially 50 to 450 nm, or most especially 50 to 250 nm; the term “periodicity” denotes the distance between, for instance, 2 neighbouring peak centers of the grating (measured in direction perpendicular to the grating length). The grating depth is preferably from the range 30 to 1000 nm, especially 50 to 800 nm (measured from peak top through the cross section to the deepest level of the trench). The cross section of the grating peaks may be of various forms, e.g. in the form of waves, such as sinusoidal, or angled, for example trapezoidal, triangular or preferably rectangular (e.g. square, with aspect ratio roughly being 1:1), thus resulting in edges extending over the length of the grating. The aspect ratio (cross-sectional width:depth) is generally from the range 1:10 to 10:1, preferably from the range 1:5 to 5:1 (a ratio of about 1 standing for a typical square cross section of the grating peak).

The device of the invention typically is based on a rectangular or trapezoidal grating, whose duty cycle (i.e. ratio of peak area to the total area) is from the range 0.1-0.9.

A thin, interrupted layer of metal is then provided on the grated substrate. Interrupted metallic structures on the surface of the transparent substrate, as required in the device of the present invention, typically are prepared by partial metallization of the surface by processes such as vapor deposition, sputtering, printing, casting or stamping. Full coverage of the surface by metal can be prevented, for example, by application of a shadow mask, photoresist techniques. In a preferred method, the metal structures are applied by directed deposition of the metal under an oblique angle onto a previously prepared grating structure, e.g. on a resin surface. This is typically achieved by exposure of the grated substrate to metal vapor under an oblique angle (e.g. 30-60°) with respect to the plane of the substrate. The deposition is typically effected on top, and on one or two sides of the grating (as schematically shown in FIGS. 4a and 5a). The layer on top of the grating may be subsequently removed, e.g. by dissolving an underlayer previously deposited, or by removal using a sticky tape, or by an etching process such as plasma etching, thus enlarging the total transparency of the device, and in case of metal deposition on both sides of the grating thereby the mean periodicity of the interrupts may be halved (schematically shown in FIG. 6a). On these rectangular gratings, certain nanoplanes covered with metal form an angle of about 90° relative to the substrate plane.

Alternative devices based on sinusoidal gratings or triangular gratings are shown in FIGS. 8 and 9. On these alternative gratings, certain nanoplanes covered with metal form angles typically from the range of about 30 to 60° relative to the substrate plane.

The metal layer may also deposited vertically, thus also covering the trenches between grating peaks, with subsequent removal of the metal layer on top of the grating as described above.

The patterned metallic film thus obtained does not cover the grating entirely.

This deposition step may be established for example by vacuum vapor deposition, sputtering, printing, casting or stamping or a combination of at least two of theses processes. Preferably, the metal is deposited by vacuum vapor deposition because this process has a high accuracy concerning the thickness of the deposited materials.

Previous to the deposition of the metal, an underlayer may be deposited upon the grated structure, e.g. for mediating adhesion of the metal and/or improving the coating quality of the subsequent metal layer (e.g. reducing its roughness). Materials useful for this underlayer (enhancement materials) include the metals Ti, Cr, Ni, Silver oxides, PEDOT-PSS. An schematic example for a cross section of such a device containing an underlayer of an enhancement material is shown in FIG. 7a (in air) and in FIG. 7b (encapsulated form).

Additionally a further material may be deposited onto the metallized device thus obtained (cover layer). This might be a polymer layer, e.g. of a material as used for the substrate, that protects the metallic structure, for example against oxidation, or that helps to adjust the optical properties. FIGS. 7c and 7d schematically show such a device additionally comprising a cover layer (7c: in air; 7d: encapsulated; shaded lines in contact with substrate symbolize the enhancement layer; thick black lines symbolize the metallic cover; further shaded line symbolizes the cover layer).

The surface quality of the layers or films may be checked by tapping mode atomic force microscopy (AFM), Dimension 3100 close loop (Digital instrument Veeco metrology group). Both height and phase images are obtained during the scanning of samples. In general, the height image reflects the topographic change across the sample surface while the phase image reflects the stiffness variation of the materials. The mean roughness Ra represents the arithmetic average of the deviation from the center plane:

$${R}_{a} = \frac{{\sum }_{i = 1}^{N} \vert {Z}_{i} - {Z}_{cp} \vert}{N}$$

Here, Zcp is the Z value of the center plane.

The periodicity of the interrupts in the metallic structure (e.g. metallic layer) is generally determined by the period of the underlying grating (P) as well, and is typically from the range 50-1000 nm, for example 100-1000 nm, especially 100-800 nm.

The device of the invention generally may have a duty cycle (i.e. ratio of the area covered by metal to the total area) ranging from 0.1-0.9; typically, about 50% (such as 30-70%, corresponding to a duty cycle 0.3-0.7) of the transparent substrate (e.g. the window pane) are covered by metal.

The metallic structure is preferably deposited in form of an interrupted layer on a structured substrate; the structure is especially a grating structure of periodicity and depth as indicated above. The grating structure thus provides peaks and valleys (trenches) on the surface.

As provided in the production process, typically by metal vapor deposition onto the prestructured, typically grated, substrate under an oblique angle, the metallic structure has a top layer thickness (peak layer thickness) typically from the range 0-40 nm, a side layer thickness typically from the range 0-20 nm (double sided as shown in FIGS. 4a and 4b; or one sided as shown in FIGS. 5a and 5b),

and a bottom layer thickness (i.e. in the grating valley) typically from the range 0-20 nm, subject to the condition that at least one of the layers (top, side or bottom) has a thickness of 1 to 75 nm, typically from the range 1 to 50 nm, preferably 5 to 50 nm, especially 5 to 40 nm, more especially 5 to 30 nm, and that at least one side of the structure's cross-section (i.e. at least one part of its bottom, top and/or sides) is uncovered by metal (indicated above as “thickness 0 nm”). As a general rule, optimum thickness of the metallic layer also depends on the exact material of this structure, where metallic elements such as silver, aluminum, gold, copper, platinum etc. typically may be applied at a lower thickness, while typical semiconductors, which may also be used for the present metallic layer such as silicon, indium tin oxid, indium oxide, aluminum doped zinc oxide or gallium doped zinc oxide, are advantageously applied with a higher thickness, which may also exceed the 75 nm (ranging e.g. up to 150 nm). The metallic structures or sections of metallic layer (between the interruptions) may be symmetrical or unsymmetrical to the normal of the substrate plane. Thicker metallic layers above 50 nm generally are combined with a relatively short periodicity of interruptions of the metallic layer of less than 500 nm, which have been noted further above.

The roughness Ra of the metallic layer typically is below 10 nm; especially preferred is a metallic layer of roughness below 5 nm.

UV cured polymer materials, films as well as grating structures as obtained after replication, typically have a thickness of 1-100 micrometer, especially 3-20 micrometer. The material of the substrate and encapsulation medium may, for example, be selected form the group consisting of a polymer, a glass, a ceramic, or two or more thereof. In a preferred embodiment the medium comprises a polymer layer. This polymer layer preferably comprises more than 20% of weight of a polymer, more preferably more than 50% of weight and even more preferably the polymer layer is a polymer. The medium or polymer layer may have a thickness in the range of 100 nm to 1 mm, preferably in the range from 500 nm to 0.5 mm and even more preferably in the region from 800 nm to 200 μm.

In a preferred embodiment, the substrate and/or the medium comprises at least one thermoplastic polymer. This thermoplastic polymer preferably comprises more than 20% of weight of a thermoplastic polymer, more preferably more than 50% of weight and even more preferably the thermoplastic polymer layer is a thermoplastic polymer. The substrate preferably comprises a hot embossable polymer or a UV curable resin or at least two thereof.

The substrate as well as the embedding medium/encapsulation materials are typically selected from glass, polymers such as acrylates (typically polymethylmethacrylate, PMMA), polyethylen terephthalate (PET), polycarbonate (PC), polyvinyl butyrate (PVB), low refractive index composite materials or hybrid polymers such as Ormocer® (, and sheets or films thereof, e.g. holographic films, such as acrylate-coated PET, radiation-curable compositions.

The substrate and/or the encapsulation medium preferably comprises a polymer selected from the group consisting of polymethyl methacrylate, polyethylene terephthalate, polyethylene, polycarbonate, polyetherimide, polyetherketone, polyethylene naphthalate, polyimide, polystyrene, poly-oxy-methylene, polypropylene, poly vinyl chloride, polyvinylbutyral, radiation curable compositions, or two or more thereof.

The UV cured polymer material, typically a polymer film, is prepared by irradiation of a radiation-curable composition, preferably during or directly after the embossing step.

Radiation-curable compositions generally are based on (and consist essentially of) oligomers and/or polymers, which comprise moieties capable to undergo crosslinking reactions upon irradiation e.g. with UV light. These compositions thus include UV-curable systems based on oligomeric urethane acrylates and/or acrylated acrylates, if desired in combination with other oligomers or monomers; and dual cure systems, which are cured first by heat or drying and subsequently by UV or electron irradiation, or vice versa, and whose components contain ethylenic double bonds capable to react on irradiation with UV light in presence of a photoinitiator or with an electron beam. Radiation-curable coating compositions generally are based on a binder comprising monomeric and/or oligomeric compounds containing ethylenically unsaturated bonds (prepolymers), which, after application, are cured by actinic radiation, i.e. converted into a crosslinked, high molecular weight form. Where the system is UV-curing, it often contains a photoinitiator as well. Corresponding systems are described e.g. in Ullmann's Encyclopedia of Industrial Chemistry, 5th Edition, Vol. A18, pages 451 453. Examples are UV-curable resin systems of the Lumogen series (BASF), such as Lumogen® OVD 301. The radiation curable composition may, for example, comprise an epoxy-acrylate from the CRAYNOR® Sartomer Europe range (10 to 60%) and one or several acrylates (monofunctional and multifunctional), monomers which are available from Sartomer Europe (20 to 90%) and one, or several photoinitiators (1 to 15%) such as Darocure® 1173 and a levelling agent such as BYK®361 (0.01 to 1%) from BYK Chemie.

The substrate comprising the device as finally obtained, and typically the window pane comprising the device, may be flat or bent; curved shapes (as, for example, for automobile front screens or rear screens) are typically introduced in a molding process after production of the device of the invention.

The present invention thus includes, but is not limited to, the following embodiments:

1. A device comprising an interrupted metallic layer on the surface of a transparent substrate, characterized in that the surface is structured with nanoplanes of inclined angle relative to the substrate plane and carrying a metal coating on at least a part of said nanoplanes, where the periodicity of interruptions in the metallic layer is from the range 50 to 1000 nm, preferably 50 to less than 500 nm, more preferably 50 to 490 nm, and the thickness of the metal coating on nanoplanes of inclined angle relative to the substrate plane is from the range 1 to 50 nm, especially 5 to 30 nm.

2. The device of embodiment 1, which is a translucent construction element, such as a facade element, architectural window, vehicle window, window pane, or a translucent part such an element.

3. Device as of embodiment 1 or 2, wherein the inclined angle relative to the substrate plane is from the range 10 to 90°.

4. Device according to any of embodiments 1 to 3, wherein the nanoplanes of inclined angle relative to the substrate plane are provided in form of a grating of periodicity as specified in embodiment 1 for periodicity of interruptions in the metallic layer, and especially in form of a grating of periodicity from the range 50 to 250 nm, where the depth of the grating is from the range 30 to 1000 nm, which grating is essentially of sinusoidal, trapezoidal, triangular or preferably rectangular cross section, and has preferably an aspect ratio from the range 1:10 to 10:1.

5. Device according to any of embodiments 1-4, wherein the metallic layer is covered by a transparent medium in form of an encapsulating layer, which medium is preferably a thermoplastic polymer or UV-cured polymer.

6. Device according to any of the embodiments 1-5, comprising between substrate and metallic layer and/or between the metallic layer and encapsulating layer one or more further layers selected from underlayers of enhancement materials and cover layers.

7. Device according to any of the embodiments 1-6, wherein the structure of the metallic layer contains, and preferably consists essentially of, a metal selected from the group consisting of silver, aluminum, gold, copper, platinum.

8. Device according to any of the embodiments 1-7, wherein the substrate, optional encapsulating layer(s) and optional cover layer(s) are glass, or are polymeric materials, which polymeric materials are typically selected from thermoplastic polymers and UV-cured polymers such as acrylic polymers, polycarbonates, polyesters, polyvinylbutyrate, polyolefines, polyetherimides, polyetherketones, polyethylene naphthalates, polyimides, polystyrenes, polyoxymethylene, polyvinylchloride, low refractive index composite materials or hybrid polymers, radiation-curable compositions, or two or more thereof.

9. A translucent construction element comprising a layer of translucent substrate, which contains a surface structured with nanoplanes of inclined angle relative to the substrate plane, and coated with an interrupted metallic layer covering at least a part of said nanoplanes, characterized in that the thickness of the metallic layer is from the range 1 to 50 nm, especially 5 to 30 nm, and the periodicity of interruptions in the metallic layer is from the range 50 to 1000 nm, preferably 50 to less than 500 nm, more preferably 50 to 490 nm, especially 50 to 250 nm.

10. Device according to any of the embodiments 1-8, which is a translucent construction element, or forms a translucent part of such an element, the element comprising a layer of translucent substrate, which contains a surface structured with nanoplanes of inclined angle relative to the substrate plane, and coated with an interrupted metallic layer covering at least a part of said nanoplanes, characterized in that the periodicity of interruptions in the metallic layer is from the range 50 to less than 500 nm, especially 50 to 490 nm, more especially 50 to 250 nm, and the thickness of the metallic layer on the nanoplanes of inclined angle relative to the substrate plane is from the range 1 to 75 nm, especially 1 to 50 nm, more especially 5 to 30 nm.

11. Translucent construction element according to embodiment 2, 9 or 10, which is a facade element, or especially is transparent and is a window pane, for example of an architectural window or a vehicle window.

12. Translucent construction element of embodiment 2 or any of 9-11, wherein the nanoplanes on the substrate surface are provided in form of a grating of periodicity from the range as specified in embodiment 1 for the periodicity of interruptions in the metallic layer, and of depth from the range 30 to 1000 nm, which grating is essentially of sinusoidal, trapezoidal, triangular or preferably rectangular cross section, and has preferably an aspect ratio from the range 1:10 to 10:1.

13. Device or translucent construction element according to any of embodiments 1-12, which is integrated in a building or vehicle with its grating lines aligned horizontally.

14. Window pane comprising a device or translucent construction element according to any of embodiments 1 to 13, wherein the substrate comprises a flat or bent polymer film or sheet, or glass sheet, or a polymer film or sheet and a glass sheet.

15. Window pane as of embodiment 14 comprising a glass sheet carrying the device including the interrupted metallic layer on at least a part of its surface, preferably on 50-100% of its surface, wherein the metallic structures are directly attached to the glass surface or are embedded in a transparent medium comprising the substrate and the encapsulating medium, where substrate and the encapsulating medium are preferably selected from thermoplastic polymers and UV-cured polymers such as acrylic polymers, poly-carbonates, polyesters, polyvinylbutyrate, polyolefines, polyetherimides, polyether-ketones, polyethylene naphthalates, polyimides, polystyrenes, polyoxymethylene, poly-vinylchloride, low refractive index composite materials or hybrid polymers, radiation-curable compositions, or two or more thereof.

16. Method for reducing the transmission of solar light, especially for seasonal modification of transmission of solar light such as IR radiation from the range 700 to 1200 nm, through a translucent, especially transparent, element such as a polymer film, plastic screen, plastic sheet, plastic plate, glass screen, especially from windows and architectural glass elements for vehicles or buildings, which method comprises integrating a translucent construction element or device according to any of embodiments 1 to 13 into said element, especially window or architectural glass element.

17. The use of a device or translucent construction element according to any of embodiments 1 to 13, or of a window pane according to embodiment 14 or 15, for heat management, especially seasonal heat and/or light management, for example for reducing entry of IR radiation and/or modifying entry of visible or ultraviolet light through a window into the interior space of a building or vehicle.

The following examples illustrate the invention. Wherever noted, room temperature (r.t.) depicts a temperature from the range 22-25° C.; over night means a period of 12 to 15 hours; percentages are given by weight, if not indicated otherwise. ISO 9050 has been applied in the second edition 15. August 2003; ISO 13837 has been applied in the first edition 15. April 2008.

### ABBREVIATIONS

T_{TS} Total solar energy transmittance (ISO 9050, ISO 13837)

T_{VIS} Visible solar energy transmittance (ISO 9050, ISO 13837)

SEM Scanning Electron Microscopy

### EXAMPLES

### Example 1

### Simulation of Light Reflection by Structured Silver Layer in Glass

The device comprises a rectangular grating of the period 390 nm, grating depth of 300 nm and duty cycle of 0.5 as schematically shown in FIG. 4a (duty cycle is the ratio of the area covered by grating peaks to the total area). As encapsulation material, borosilicate glass BK7 is chosen, whose index of refraction is similar to plastics, resulting in the encapsulated device as shown in FIG. 4b. The thickness of the encapsulating glass is larger than 5 μm and has no effect on the optical properties of the device. The peaks of the rectangular grating are coated on all 3 sides (side-walls and top) by silver of 8 nm thickness. Optical properties of the device are simulated and optimized using the rigorous coupled wave analysis (RCWA). Details of the RCWA method, which represents an industry standard for the simulation of the optical properties of gratings, have been published inter alia in “Diffraction analysis of dielectric surface-relief gratings”, M. G. Moharam, JOSA A, 72, 1385-1392 (1982); and in “Light Propagation in Periodic Media” by Michel Nevière and Evgeny Popov, Marcel Dekker Inc., New York, 2003. The appearing visual color of the device is evaluated in transmission and reflection from the simulated spectra. Total solar transmittance (TTS, ISO 13837) and the transmission in the visible TVIS (ISO 9050) are calculated at various angles of incidence (relative to the plane of the grating and its cross section, each perpendicular to the direction of the grating, as shown in FIG. 1), from the zeroth order transmission and reflection. For the targeted application, the particular incidence angles of 0° (perpendicular incidence of light) and ±60° (grazing light) are considered.

Results (according to ISO 13837 and ISO 9050) are compiled in the below table;

TABLE
TTS and TVIS depending on the incidence angle the
resulting ratio T_{TS}(0°)/T_{TS}(60°) is 1.27.

| Angle | T_{TS} | T_{VIS} |
|---|---|---|
| 0° | 71% | 79% |
| ±60° | 56% | 78% |

FIGS. 10 and 11 show the device's transmission and reflection spectra for angles of incidence 0° and 60° thus obtained.

### Example 2

### Fabrication and Testing of a Structured Silver Layer

A device is prepared, which holds an asymmetric cross-section as illustrated in FIG. 5a and which is encapsulated in a dielectric material as illustrated in FIG. 5b. The device comprises a grating of period 370 nm, grating depth of 300 nm and a duty cycle of 0.4. As the metal, silver is chosen with target thickness of 14 nm. The encapsulation material is a UV curable resin (Lumogen® OVD 301 from BASF). The substrate is a borosilicate glass B270 sheet with a size of 50×50×0.7 mm³.

The device is prepared as follows:
i) A layer of UV curable material (Lumogen® OVD 301 from BASF) of thickness 5-10 μm is applied to one side of the final glass substrate (size 50×50×0.7 mm) by drop-casting. The wet layer of UV curable material is embossed with a tool comprising a rectangular grating of dimension as described above and cured, in accordance with the method described by Gale et al., Optics and Lasers in Engineering 43, 373 (2005), section 2.3. The thickness of the UV curable material has no major effect on the optical properties in the wavelength range of interest.
ii) The replicated grating is then exposed to physical vapour deposition of silver from the side using a thermal evaporator vacuum chamber. The silver thickness selected is 14 nm, evaporation angle is 45° such that only a part of the grating is metalized as illustrated in FIG. 5a.
iii) Finally, the device is encapsulated by coating the structures with another layer of

UV curable material (Lumogen® OVD 301 from BASF; approximately 10 micrometer; thickness of the UV curable material has no major effect on the optical properties at the wavelength range of interest) and finally covered with another sheet of glass of same size.

The transmission and reflection spectra are measured by means of a photospectrometer. Since the Ag structure is asymmetric (see FIG. 1b), there are two directions under which measurements under 60° can be made (indicated as +60° and −60°). In the present case, measurements are taken at −60°). Since detection of 0° reflection (=perpendicular irradiation) it is not possible with the present equipment, the measurement is carried out under the small angle of 6°, where reflection intensity is nearly identical with exact normal reflection. FIG. 2 shows the transmission spectrum for an angle of incidence at 0°, and the reflection spectrum of the device thus obtained for an incidence angle of 6°. FIG. 3 shows the measurement for θ=−60°.

With the measured transmission and reflection spectra at 0° (6°) and −60°, the ISO numbers and transmission colours are evaluated and shown in the following table:

TABLE
Percentage of T_{TS} and T_{VIS} and the color
c depending of the illumination angle;

| angle θ | T_{TS} | T_{VIS} | color c* |
|---|---|---|---|
| 0° (6°) | 58.0% | 57.7% | 22.2 |
| −60° | 47.8% | 31.1% | 17.5 |

*the color value c is based on the color space L*a*b and its coordinates a and b, with c = \sqrt{a² + b^{²}}. c is a measure for the color saturation

ISO numbers are calculated according to the international standard ISO 9050 and 13837.

The ratio of T_{TS}(0°)/T_{TS}(−60°) is 1.21.

Using the UV-curable material NOA 61 or NOA 63 from Norland Products instead of Lumogen® OVD 301 leads to very similar results

The device shows a good angle sensitivity.

### Example 3

### Simulation of Light Reflection and Transmission for Short Period

Simulations are carried out using the same simulation tools as described in example 1. For simulated devices, the encapsulation material is poly(methyl methacrylate) (PMMA). The cross-section through the device is as illustrated in FIG. 5b. The period P of the devices is 190 nm with a horizontal grating orientation. Such a short grating period does not lead to light redirection by diffraction in the visible and near infrared wavelength range.

FIG. 12 illustrates the definition of the used geometrical grating parameters P, D, DC, dₜₒₚ and d_{side}. The grating depths D are 160 nm and 180 nm and the duty cycle is 0.25. Silver is chosen for the metallic layer; silver layer thickness on top dₜₒₚ and on the side d_{side} of the grating are according to the following Table 1.

TABLE 1
silver thicknesses dₜₒₚ, d_{side} for the two devices
D = 160 nm and D = 180 nm

| D [nm] | dₜₒₚ [nm] | d_{side} [nm] |
|---|---|---|
| 160 | 16.4 | 14.6 |
| 180 | 17.2 | 13.7 |

For the two devices having grating depths D=160 nm and D=180 nm, simulations are carried out and the calculated transmission and the reflection spectra at an incident light angles θ=0° and θ=60° are shown in FIGS. 13-16.

Based on these simulated transmission and reflection spectra, the transmittance numbers T_{TS}, T_{VIS}, the colors c depending on the incidence angle θ and the angle dependence ratio T_{VIS}(0°), T_{VIS}(60°) for each device are extracted as shown in Table 2.

TABLE 2
calculated transmittance numbers T_{TS}, T_{VIS}, the colors c and the
angle dependence ratio T_{VIS}(0°), T_{VIS}(60°) for the two device
cases D = 160 nm and D = 180 nm; the ISO numbers are calculated
according to the international standard ISO 9050 and ISO 13837

| depth D | period P | θ | T_{TS} | T_{VIS} | color c | T_{TS}0°/T_{TS}60° |
|---|---|---|---|---|---|---|
| 160 | 190 | 0° | 62.0% | 72.1% | 15.6 | |
| | | 60° | 48.5% | 56.8% | 23.4 | 1.28 |
| 180 | 190 | 0° | 62.5% | 73.4% | 11.4 | |
| | | 60° | 46.6% | 59.4% | 13.1 | 1.34 |

### Example 4

### Fabrication of Device with Short Period

The device shown in FIG. 17 is prepared in accordance with the fabrication procedure outlined in the description of example 1 (including thin film evaporation, plasma etching, galvanic step, UV replication, oblique silver evaporation and encapsulation) with the following exception: The cross-section through the UV embossed grating of the device is as illustrated in FIG. 5b; the period P of the device is 195 nm with a horizontal grating orientation, the grating depths is 180 nm, duty cycle is approx. 0.3 as shown in FIG. 17. Silver is used as a metal and the physical vapour deposition is set-up such that a silver thickness of 22 nm results for perpendicular evaporation; the evaporation is carried out, however, again at an oblique angle of 35°.

The measured transmission and the reflection spectra at incident light angle θ=0° (i.e. 6°, see explanation in example 2) and θ=−60° are shown in FIGS. 18 and 19.

Based on these measured transmission and reflection spectra the ISO transmittance numbers T_{TS}, T_{VIS}, the colors c depending on the incidence angle θ and the angle dependence ratio T_{VIS}(0°), T_{VIS}(-60°) were evaluated as shown in Table 3.

TABLE 3
Calculated transmittance numbers T_{TS}, T_{VIS}, the colors c and
the angle dependence ratio T_{VIS}(0°), T_{VIS}(−60°) for
the fabricated device of example 4; the ISO numbers are evaluated
according to the international standard ISO 9050 and ISO 13837

| device | θ | T_{TS} | T_{VIS} | color c | T_{TS}0°/T_{TS}−60° |
|---|---|---|---|---|---|
| example 4 | 0° | 58.0% | 55.5% | 4.9 | |
| | −60° | 45.9% | 25.5% | 13.7 | 1.26 |

### BRIEF DESCRIPTION OF FIGURES

FIG. 1a: Perspective representation of the grated device indicating the plane of the grating comprising the interrupted metallic structure (x and y axis) and the incident light; the x-axis therein points in direction of the periodicity, the y-axis is parallel with the grating; the z-axis stands perpendicular on the substrate plane; i represents the incoming light forming an angle θ with the z-axis (θ=0° represents light falling perpendicularly on the window).

FIG. 1b: Cross-section through the device and the incidence angle of light under which transmission measurements are carried out (in the present case of example 2, −60° is chosen).

FIG. 2: Transmission and reflection spectra as detected for the device of example 2 for θ=0° incident angle (transmission, dashed line) and for θ=6° (reflection, solid line).

FIG. 3: Transmission (dashed line) and reflection (solid line) spectra as detected for the device of example 2 for θ=−60° incident angle.

FIG. 4: Cross-section of a device according to the present invention in air (FIG. 4a) and in encapsulated form (FIG. 4b; thick black lines symbolize the metallic cover).

FIG. 5: Cross-section of a representative device according to the present invention, as obtainable by metal deposition under an oblique angle (as in present example 2) in air (FIG. 5a) and encapsulated in a dielectric material (FIG. 5b; thick black lines symbolize the metallic cover).

FIG. 6: Cross-section of a device according to the present invention in air (FIG. 6a) and in encapsulated form (FIG. 6b; thick black lines symbolize the metallic cover) as obtainable after metal deposition from both sides of the grating and subsequent removal of the metal layer from the grating top.

FIG. 7: Cross-section of device comprising an underlayer of enhancement material (7a: in air; 7b: encapsulated; shaded lines symbolize the enhancement layer; thick black lines symbolize the metallic cover), and of device additionally comprising a cover layer (7c: in air; 7d: encapsulated; shaded lines in contact with substrate symbolize the enhancement layer; thick black lines symbolize the metallic cover; further shaded line symbolizes the cover layer).

FIG. 8: Alternative devices based on a sinusoidal grating in air (FIG. 8a) and in encapsulated form (FIG. 8b; thick black lines symbolize the metallic cover).

FIG. 9: Alternative devices based on a triangular grating in air (FIG. 9a) and in encapsulated form (FIG. 9b; thick black lines symbolize the metallic cover).

FIG. 10 shows the transmission and reflection spectra of a device as of present example 1 for an angle of incidence of 0°.

FIG. 11 shows the transmission and reflection spectra of a device as of present example 1 for an angle of incidence of 60°.

FIG. 12 cross-section through a single side metal grating device, with the indicated geometries: period P, grating depth D, duty cycle DC, metal thickness on top dₜₒₚ and metal thickness on side d_{side}.

FIGS. 13 and 14 show the transmission and reflection spectra for the silver based device with: D=160 nm, P=190 nm, DC=0.25 and silver thicknesses according to Table 1; spectra shown are for θ=0° (FIG. 13) and for θ=60° (FIG. 14).

FIGS. 15 and 16 show the transmission and reflection spectra for the silver based device with: D=180 nm, P=190 nm, DC=0.25 and silver thicknesses according to Table 1; spectra shown are for θ=0° (FIG. 15) and for θ=60° (FIG. 16).

FIG. 17 shows the SEM image of a cross-section through a fabricated short period grating of example 4, with a grating period of 195 nm (spacing between the vertical bars) and a depth of 180 nm.

FIG. 18 shows the transmission and reflection spectra for the silver based device of example 4 for θ=0° (6°).

FIG. 19 shows the transmission and reflection spectra for the silver based device of example 4 for θ=−60°.

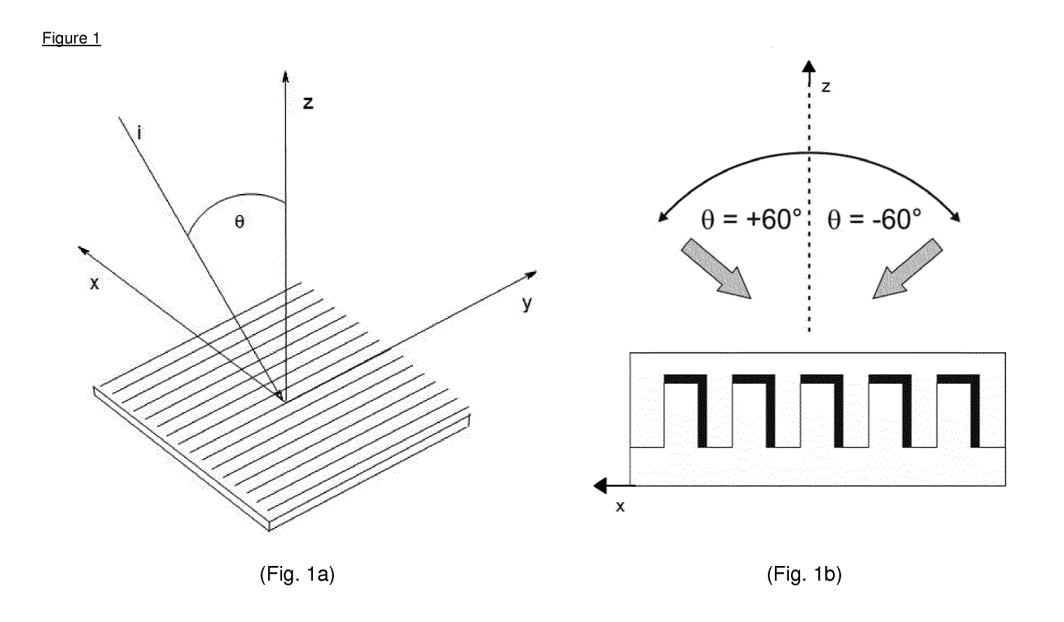

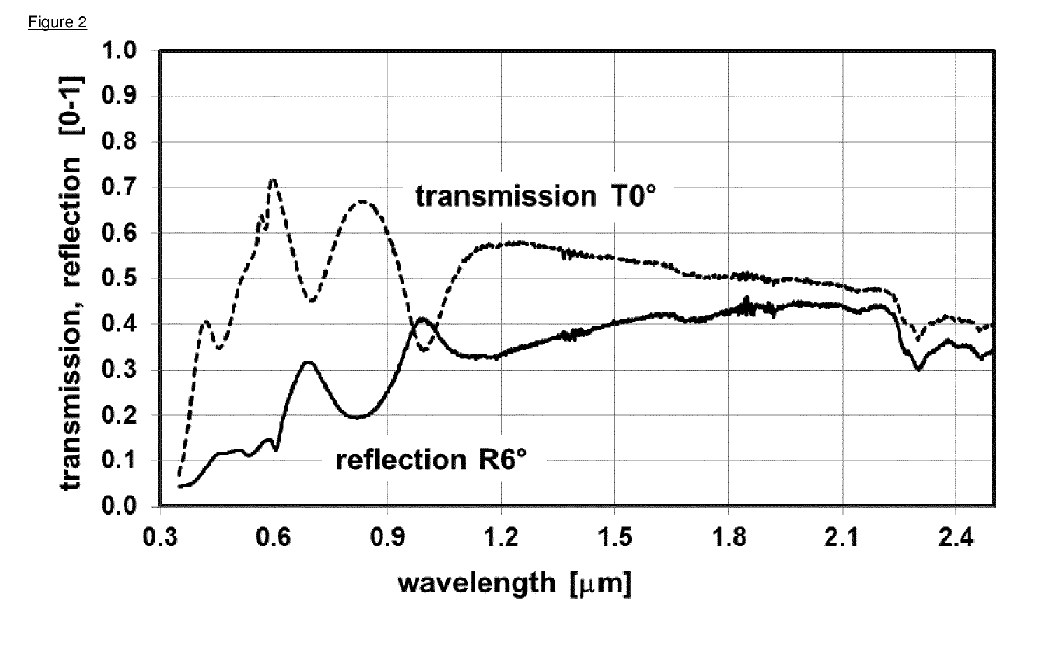

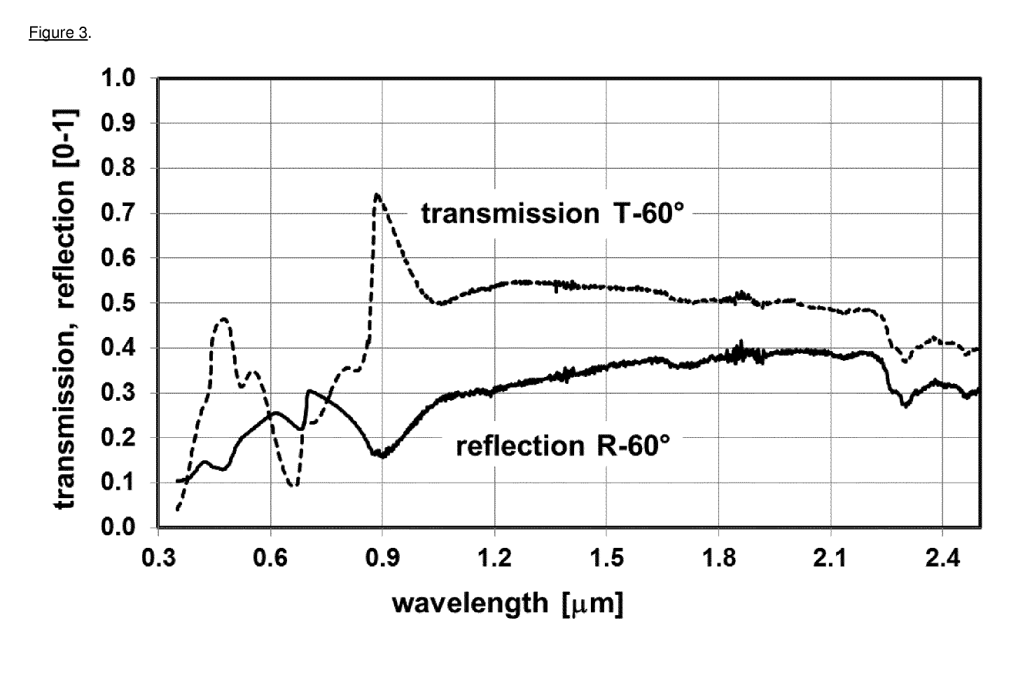

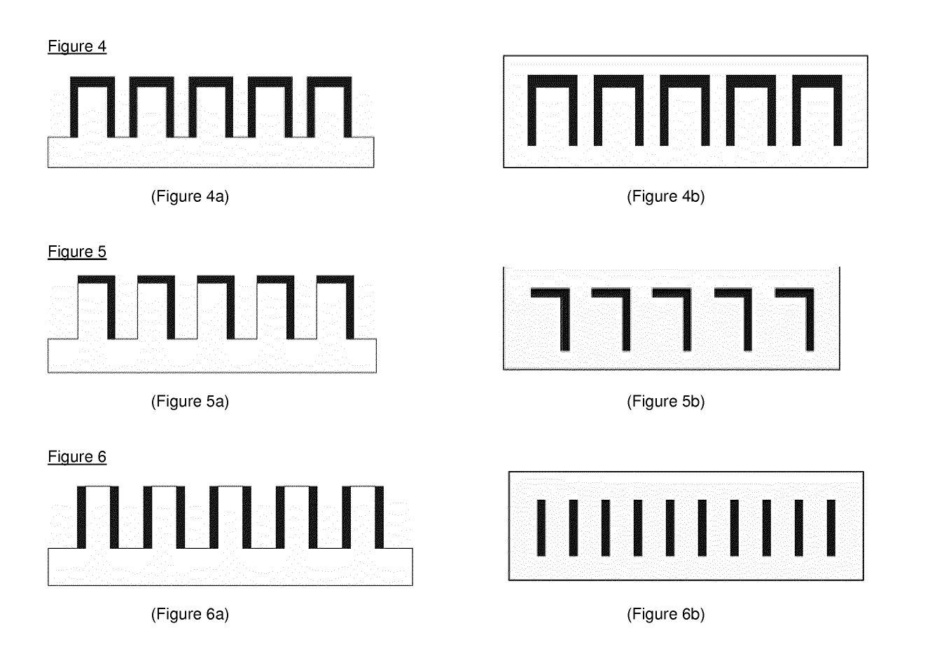

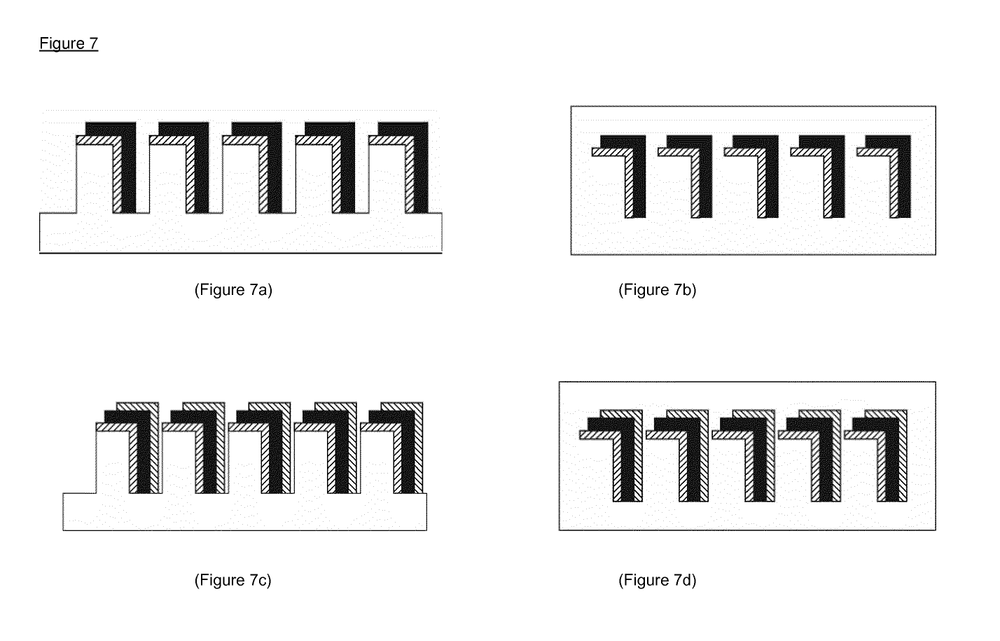

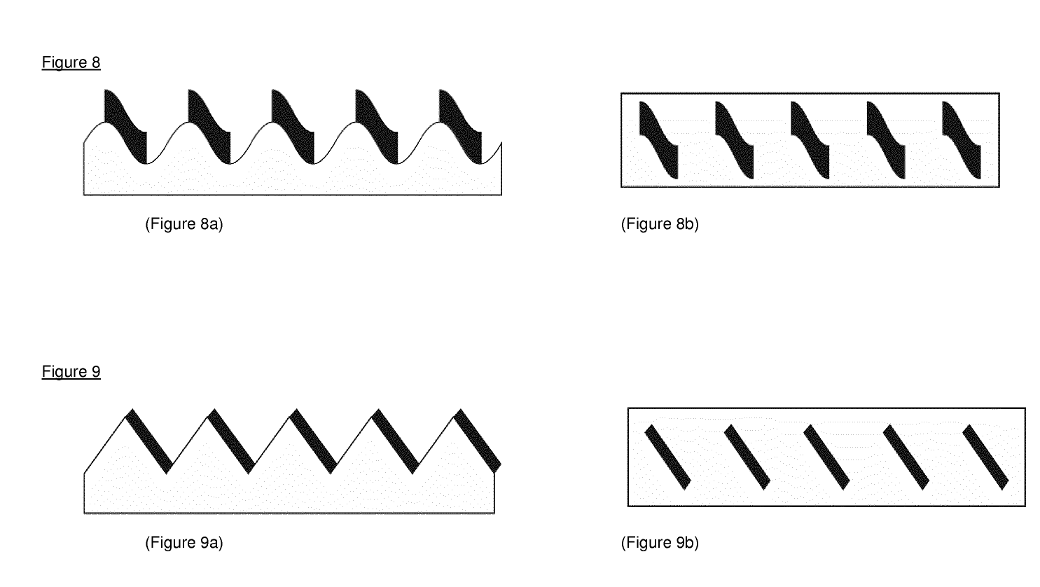

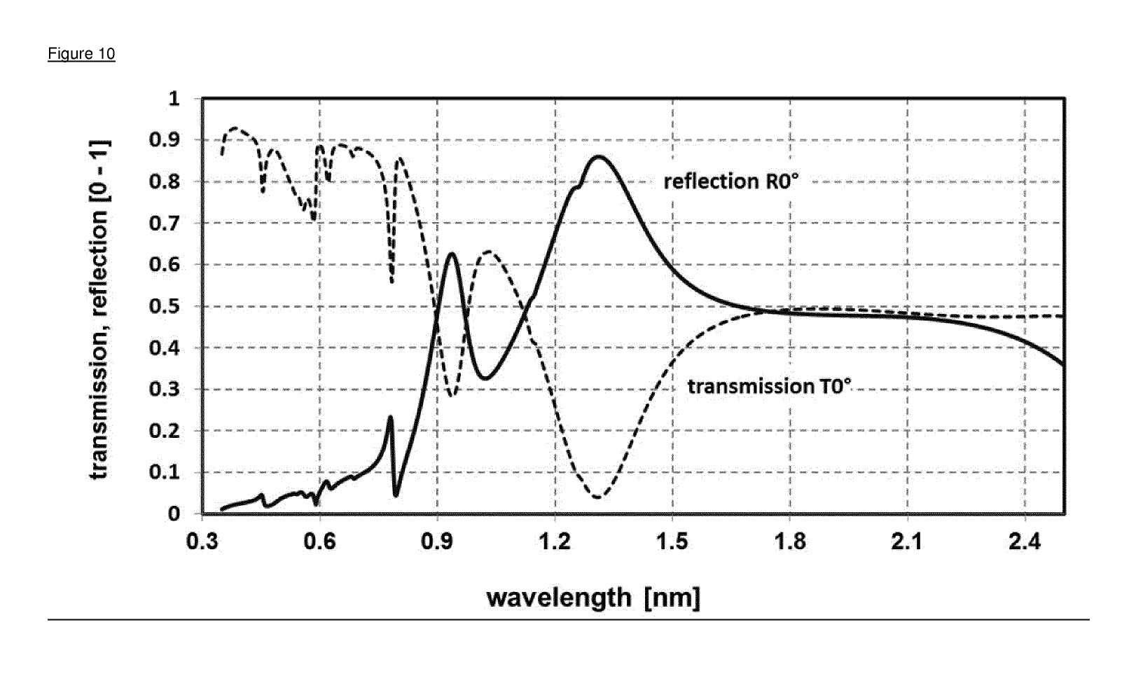

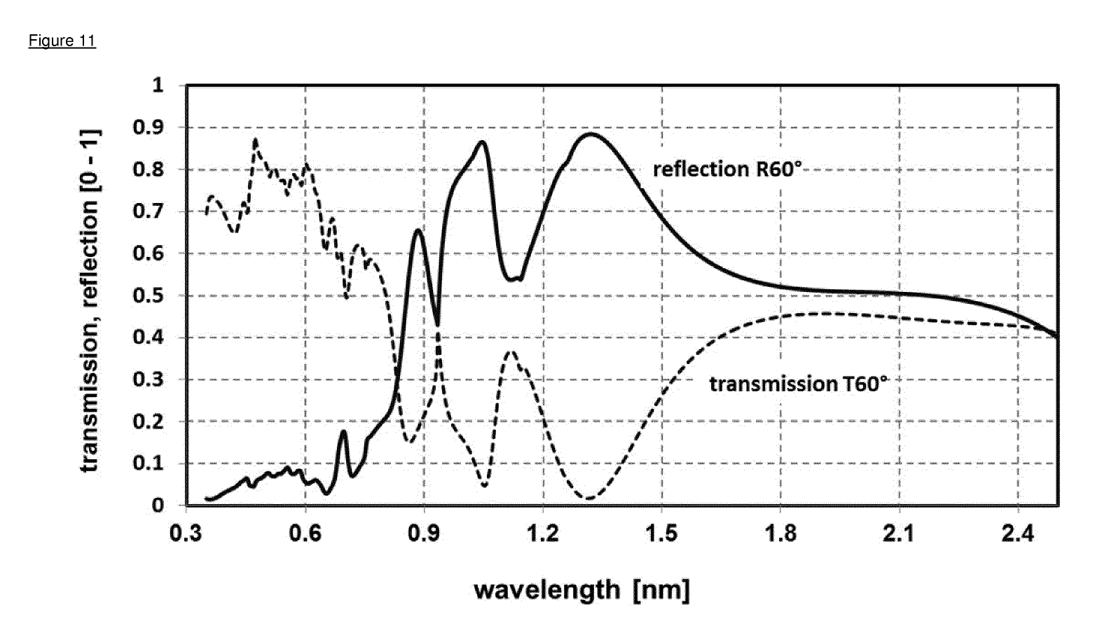

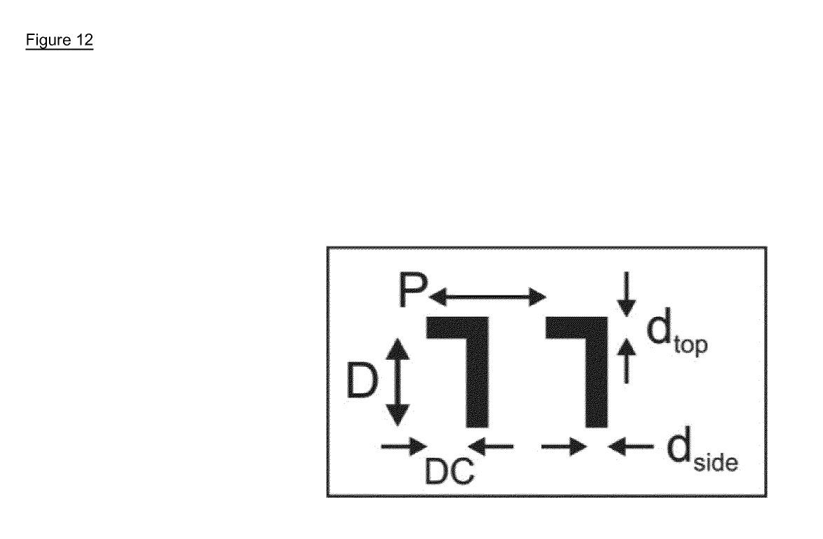

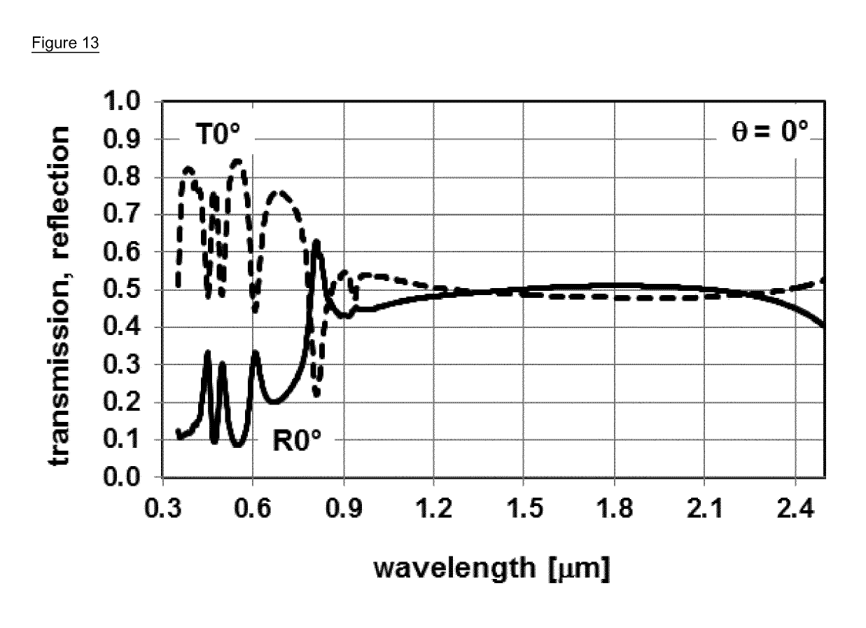

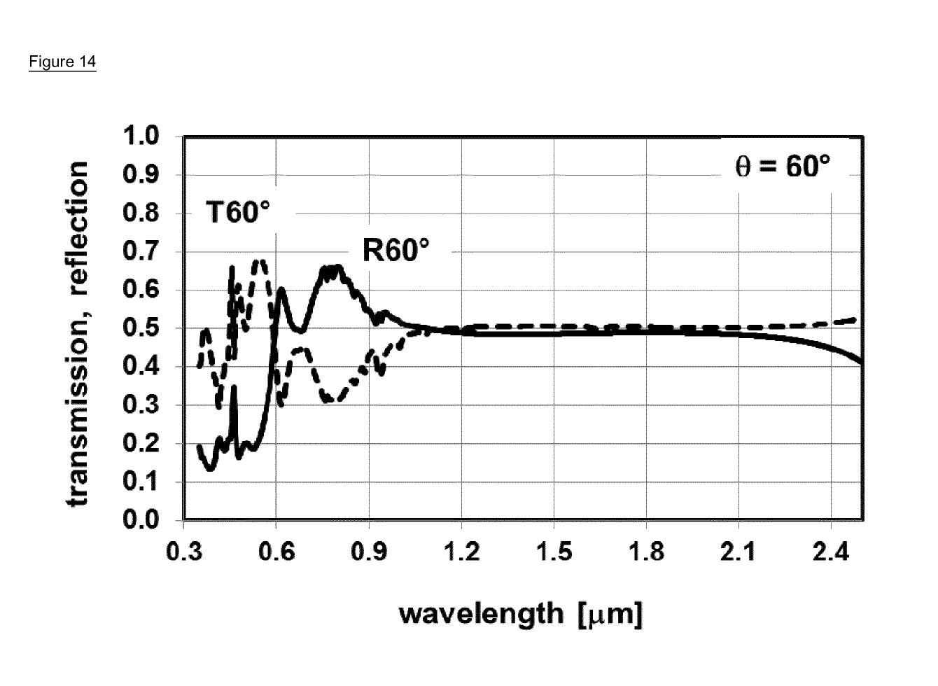

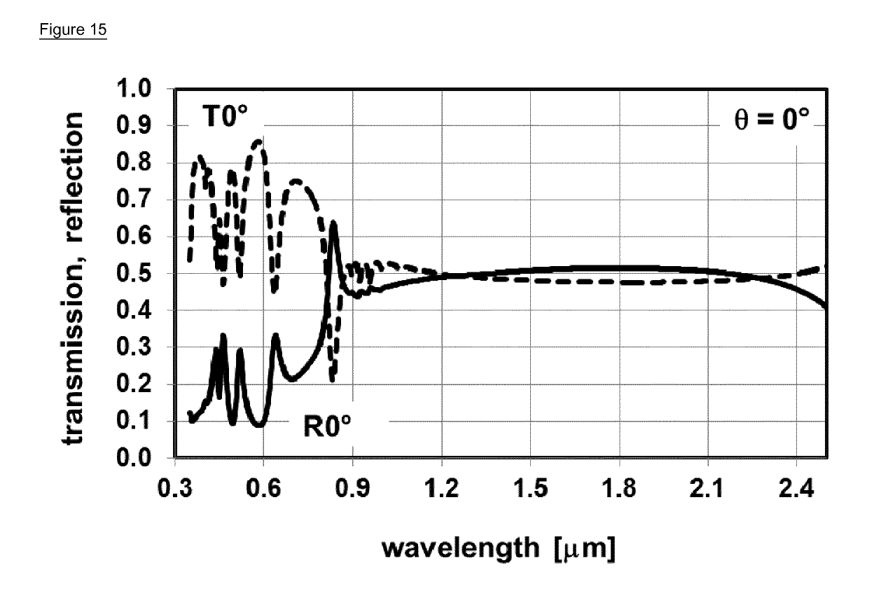

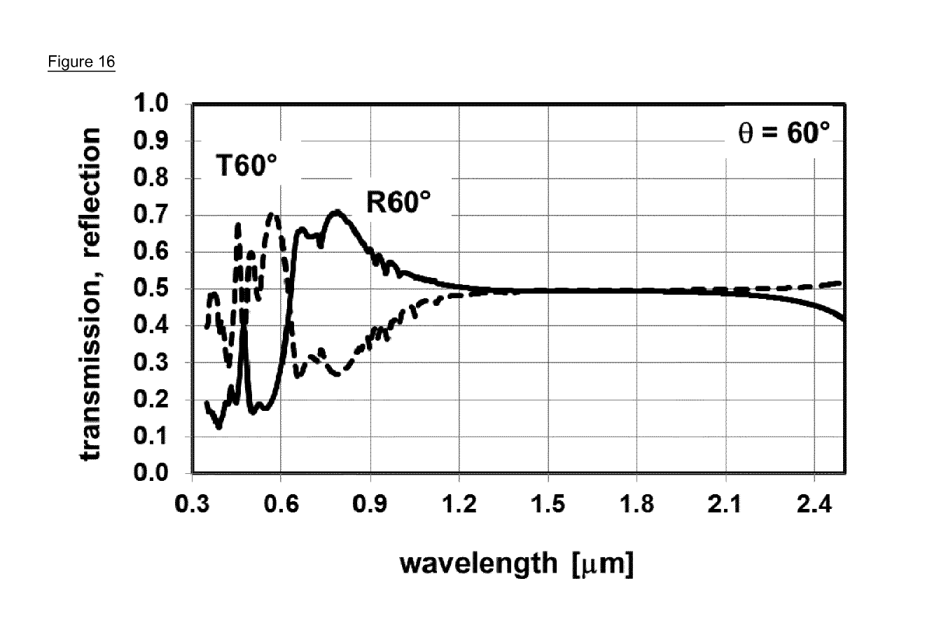

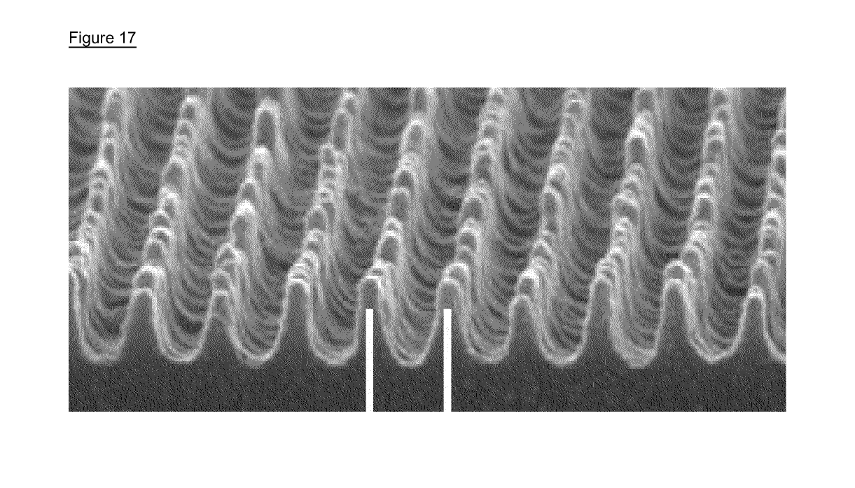

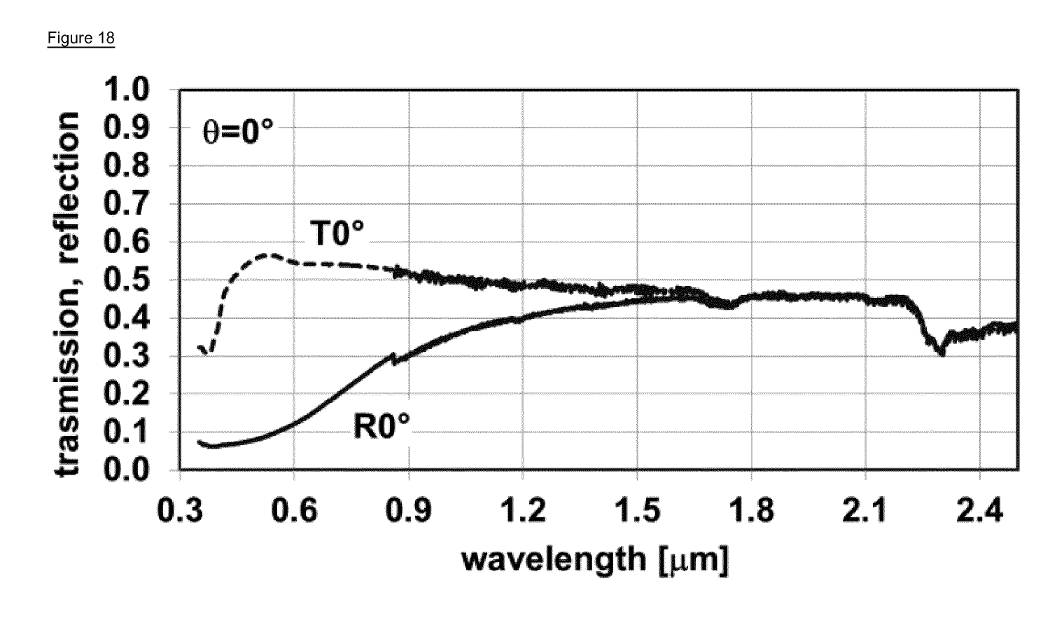

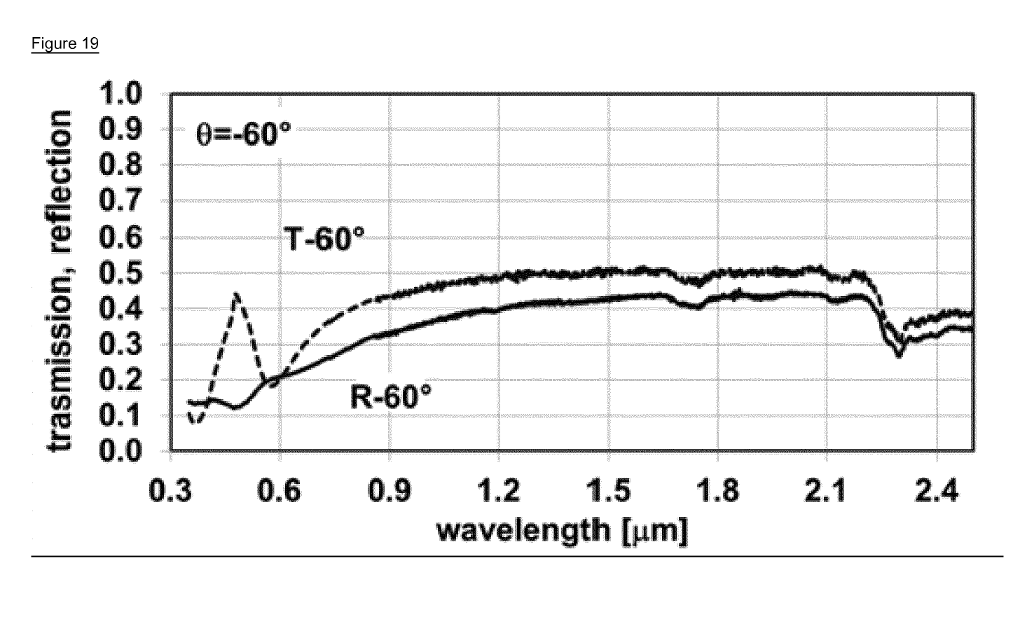

1.-16. (canceled)

17. A translucent construction element comprising a layer of translucent substrate, which contains a surface structured with nanoplanes of inclined angle relative to the substrate plane, and coated with an interrupted metallic layer covering at least a part of said nanoplanes, characterized in that the thickness of the metallic layer is from the range 1 to 50 nm and the periodicity of interruptions in the metallic layer is from the range 50 to 1000 nm

18. A translucent construction element comprising a layer of translucent substrate, which contains a surface structured with nanoplanes of inclined angle relative to the substrate plane, and coated with an interrupted metallic layer covering at least a part of said nanoplanes, characterized in that the periodicity of interruptions in the metallic layer is from the range 50 to less than 500 nm, and the thickness of the metallic layer is from the range 1 to 75 nm.

19. The translucent construction element of claim 17, wherein the element is a facade element, or is transparent and is a window pane.

20. The translucent construction element of claim 17, wherein the nanoplanes on the substrate surface are provided in form of a grating of depth from the range 30 to 1000 nm, which grating is of sinusoidal, trapezoidal, triangular or rectangular cross section.

21. The translucent construction element of claim 20, wherein the element is integrated in a building or vehicle with its grating lines aligned horizontally.

22. A device comprising an interrupted metallic layer on the surface of a transparent substrate, characterized in that the surface is structured with nanoplanes of inclined angle relative to the substrate plane and carrying a metal coating on at least a part of said nanoplanes, where the periodicity of interruptions in the metallic layer is from the range 50 to 1000 nm and the thickness of the metal coating is from the range 1 to 50 nm.

23. The device of claim 22, wherein the inclined angle relative to the substrate plane is from the range 10 to 90°.

24. Device of claim 22, wherein the nanoplanes of inclined angle relative to the substrate plane are provided in form of a grating of periodicity from the range 50 to 1000 nm and of depth from the range 30 to 1000 nm, which grating is of sinusoidal, trapezoidal, triangular or rectangular cross section.

25. The translucent construction element according to claim 17, wherein the metallic layer is covered by a transparent medium in form of an encapsulating layer.

26. The translucent construction element according to claim 17, comprising between substrate and metallic layer and/or between the metallic layer and encapsulating layer one or more further layers selected from underlayers of enhancement materials and cover layers.

27. The translucent construction element according to claim 17, wherein the metallic layer contains a metal selected from the group consisting of silver, aluminum, gold, copper, and platinum.

28. The translucent construction element according to claim 17, wherein the substrate, an optional encapsulating layer(s) and an optional cover layer(s) are glass or polymeric materials selected from the group consisting of thermoplastic polymers and UV-cured polymers such as acrylic polymers, polycarbonates, polyesters, polyvinylbutyrate, polyolefines, polyetherimides, polyetherketones, polyethylene naphthalates, polyimides, polystyrenes, polyoxymethylene, polyvinylchloride, low refractive index composite materials, hybrid polymers, radiation-curable compositions, and combinations thereof.

29. A window pane comprising the translucent construction element according to claim 17, wherein the substrate comprises a flat or bent polymer film or sheet, or glass sheet, or a polymer film or sheet and a glass sheet.

30. The window pane of claim 29 comprising a glass sheet carrying the element including the interrupted metallic layer on at least a part of its surface, wherein the metallic structures are directly attached to the glass surface or are embedded in a transparent medium comprising the substrate and the encapsulating medium, where substrate and the encapsulating medium are selected from the group consisting of thermoplastic polymers, UV-cured polymers such as acrylic polymers, polycarbonates, polyesters, polyvinylbutyrate, polyolefines, polyetherimides, polyetherketones, polyethylene naphthalates, polyimides, polystyrenes, polyoxymethylene, polyvinylchloride, low refractive index composite materials, hybrid polymers, radiation-curable compositions, and combinations thereof.

31. A method for reducing the transmission of solar light through a transparent element, which method comprises integrating the translucent construction element according to claim 17 into said transparent element.

32. A method for seasonal heat and/or light management, comprising incorporating the translucent construction element according to claim 17into a window into the interior space of a building or vehicle.
